(19) United States
(12) Patent Application Publication
(10) Pub. No.: US 2026/0316750 A1
(43) Pub. Date: Oct. 15, 2026

(54) ASSISTED EVASIVE STEERING SYSTEM FOR A VEHICLE

(71) Applicant: GM Global Technology Operations LLC, Detroit, MI (US)

(72) Inventors: Riley Stroven, Northville, MI (US); Milad Jalaliyazdi, Richmond Hill (CA); Tetyana V. Mamchuk, Novi, MI (US); Reza Zarringhalam, Whitby (CA)

(73) Assignee: GM Global Technology Operations LLC, Detroit, MI (US)

(21) Appl. No.: 19/174,774

(22) Filed: Apr. 9, 2025

(51) Int. Cl. B60W 30/095; B60W 10/20

(52) U.S. Cl. CPC B60W 30/095; B60W 10/20; B60W 2540/18; B60W 2554/80

(57) ABSTRACT

A computer-implemented method when executed by data processing hardware causes the data processing hardware to perform operations. The operations include receiving, at an assisted evasive steering algorithm, sensor data from a plurality of sensors disposed within a vehicle, identifying, based on the sensor data, a target relative to the vehicle, and monitoring, via the assisted evasive steering algorithm, a distance between the vehicle and the target during a time frame based on the sensor data. The operations also include detecting, based on the sensor data, a driving maneuver of the vehicle relative to the target and executing, based on the driving maneuver, an assistive maneuver. The assistive maneuver includes generally straightening a trajectory of the vehicle while maintaining a position of the vehicle defined by the driving maneuver.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to an assisted evasive steering system for a vehicle.

Conventional vehicles may be equipped with various forms of assistive driver systems designed to provide support to drivers during operation of the vehicle. For example, some of the systems may include tracking a following distance to a forward vehicle, blind spot monitoring, and adaptive cruise control, among others. Some assistive driver systems may also include lane monitoring and may provide guided correction during operation of the vehicle and/or during execution of a lane change maneuver. In some cases, the driver may oversteer during a maneuver, and the assistive driver system may provide a correction. However, the correction may cause the driver to react or otherwise be unsettled by a pull of the steering wheel executed by the assistive driver system. Thus, there is a need for tuning assistive driver systems to provide metered corrections to minimize a potential reactive driver response.

### SUMMARY

In some aspects, a computer-implemented method when executed by data processing hardware causes the data processing hardware to perform operations. The operations include receiving, at an assisted evasive steering algorithm, sensor data from a plurality of sensors disposed within a vehicle, identifying, based on the sensor data, a target relative to the vehicle, and monitoring, via the assisted evasive steering algorithm, a distance between the vehicle and the target during a time frame based on the sensor data. The operations also include detecting, based on the sensor data, a driving maneuver of the vehicle relative to the target and executing, based on the driving maneuver, an assistive maneuver. The assistive maneuver includes generally straightening a trajectory of the vehicle while maintaining a position of the vehicle defined by the driving maneuver.

In some examples, the assisted evasive steering algorithm may include a dynamic path adjustment. Optionally, executing the assistive maneuver may include executing the dynamic path adjustment in response to the driving maneuver. In other examples, receiving the sensor data may include receiving initial target data and initial lane data from the plurality of sensors at a first time point. The operations may also include estimating a minimum data sample based on at least one of the initial target data and the initial lane data at the first time point. The operations may further include determining the time frame for monitoring the distance between the vehicle and the target based on the minimum data sample. In some instances, the operations may include sampling the sensor data for the time frame and determining a maintained position of the vehicle during the time frame. The operations may also include resetting the time frame based on the maintained position of the vehicle.

In other aspects, an assisted evasive steering system for a vehicle includes data processing hardware and memory hardware in communication with the data processing hardware. The memory hardware stores instructions that when executed on the data processing hardware cause the data processing hardware to perform operations. The operations include receiving, at an assisted evasive steering algorithm, sensor data from a plurality of sensors disposed within the vehicle, identifying, based on the sensor data, a target relative to the vehicle, and monitoring, via the assisted evasive steering algorithm, a distance between the vehicle and the target during a time frame based on the sensor data. The operations also include detecting, based on the sensor data, a driving maneuver of the vehicle relative to the target and executing, based on the driving maneuver, an assistive maneuver. The assistive maneuver includes generally straightening a trajectory of the vehicle while maintaining a position of the vehicle defined by the driving maneuver.

In some examples, the assisted evasive steering algorithm may include a dynamic path adjustment. Optionally, executing the assistive maneuver may include executing the dynamic path adjustment in response to the driving maneuver. In some instances, receiving the sensor data may include receiving initial target data and initial lane data from the plurality of sensors at a first time point. The operations may also include estimating a minimum data sample based on at least one of the initial target data and the initial lane data at the first time point. The operations may further include determining the time frame for monitoring the distance between the vehicle and the target based on the minimum data sample. In some examples, the operations may include sampling the sensor data for the time frame and determining a maintained position of the vehicle relative to the target during the time frame. Optionally, the operations may include resetting the time frame based on the maintained position of the vehicle.

In further aspects, an assistive evasive steering system for a vehicle includes data processing hardware and memory hardware in communication with the data processing hardware. The memory hardware stores instructions that when executed on the data processing hardware cause the data processing hardware to perform operations. The operations include receiving, at an assisted evasive steering algorithm, sensor data including initial target data and initial lane data from a plurality of sensors disposed within a vehicle, estimating a minimum data sample based on at least one of the initial target data and the initial lane data at a first time point, and identifying, based on the sensor data, a target relative to the vehicle. The operations also include monitoring, via the assisted evasive steering algorithm, a distance between the vehicle and the target during a time frame based on the sensor data, the time frame determined based on the estimated minimum data sample, detecting, based on the sensor data, a driving maneuver of the vehicle relative to the target, and executing, based on the driving maneuver, an assistive maneuver. The assistive maneuver includes generally straightening a trajectory of the vehicle while maintaining a position of the vehicle defined by the driving maneuver.

In some examples, the assisted evasive steering algorithm may include a dynamic path adjustment. The operations may also include sampling the sensor data for the time frame and determining a maintained position of the vehicle relative to the target during the time frame. The operations may further include resetting the time frame based on the maintained position of the vehicle.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle equipped with an assisted evasive steering system according to the present disclosure;

FIG. 2 is a schematic view of a vehicle executing a driving maneuver relative to a target, the vehicle equipped with an assisted evasive steering system according to the present disclosure;

FIG. 3 is another schematic view of a vehicle executing a driving maneuver relative to a target, the vehicle equipped with an assisted evasive steering system according to the present disclosure;

FIG. 4 is an exemplary block diagram of an assisted evasive steering system according to the present disclosure;

FIG. 5A is an example flow diagram of operation of an assisted evasive steering system according to the present disclosure;

FIG. 5B is a continued example flow diagram of operation of the assisted evasive steering system of FIG. 5A;

FIG. 6 is another example flow diagram of operation of an assisted evasive steering system according to the present disclosure; and

FIG. 7 is an exemplary method diagram of operation of an assisted evasive steering system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

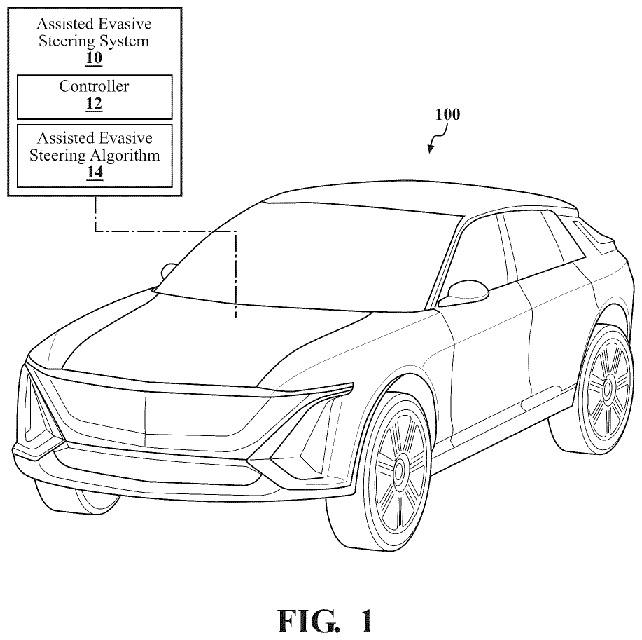

Referring to FIGS. 1-4, an assisted evasive steering system 10 is configured for a vehicle 100. The assisted evasive steering system 10 is configured to assist a driver of the vehicle 100 when executing a driving maneuver 102 relative to a target 200. For example, the target 200 may be another vehicle that the vehicle 100 equipped with the assisted evasive steering system 10 may be following or otherwise approaching. The vehicle 100 is equipped with a plurality of sensors 104 that are configured to capture sensor data 106 as the vehicle 100 travels along a roadway 210. The roadway 210 may include one or more lanes 212. The sensors 104 are configured to capture target data 108 and lane data 110. For example, the sensors 104 may detect the target 200 and capture initial target data 108a and initial lane data 110a. The initial lane data 110a may be defined by the initial target data 108a, such that lane data captured 110 prior to the target data 108 being captured is discarded by the assisted evasive steering system 10. The initial lane data 110a is defined and utilized by the assisted evasive steering system 10 in response to the initial target data 108a being captured. The processing and utilization of the sensor data 106 is described in more detail below.

The assisted evasive steering system 10 utilizes the target data 108 and the lane data 110 received from the sensors 104 to assist the driver in executing the driving maneuver 102, described herein. For example, the assisted evasive steering system 10 also includes a controller 12 of the vehicle 100 that is configured with an assisted evasive steering algorithm 14 that is configured to straighten a trajectory 120 of the vehicle 100 based on, at least in part, the driving maneuver 102 and the sensor data 106. The controller 12 includes data processing hardware 16 configured to execute the assisted evasive steering algorithm 14, described in more detail below. The controller 12 also includes memory hardware 18 in communication with the data processing hardware 16. The memory hardware 18 stores instructions that, when executed by the data processing hardware 16, cause the data processing hardware 16 to perform operations, described herein.

The assisted evasive steering algorithm 14 is configured to receive the sensor data 106 from the sensors 104. The assisted evasive steering algorithm 14 utilizes the sensor data 106 to estimate a minimum data sample 20. The minimum data sample 20 corresponds to a minimum amount of the sensor data 106 needed by the assisted evasive steering algorithm 14 to generate and execute an assistive maneuver 22. The assistive maneuver 22 is defined by the assisted evasive steering algorithm 14 generally straightening the trajectory 120 of the vehicle 100 while maintaining a position 122 of the vehicle 100 defined by the driving maneuver 102. For example, the assistive maneuver 22 is configured to provide a gentle adjustment to the driving maneuver 102 executed by the driver, such that the driver maintains overall control over the vehicle 100 during execution of the assistive maneuver 22. The assistive maneuver 22 is not configured to jerk or otherwise result in an aggressive maneuver that would startle or otherwise generate a response by the driver. For example, the assistive maneuver 22 is configured to straighten the trajectory 120 without over correcting the driving maneuver 102.

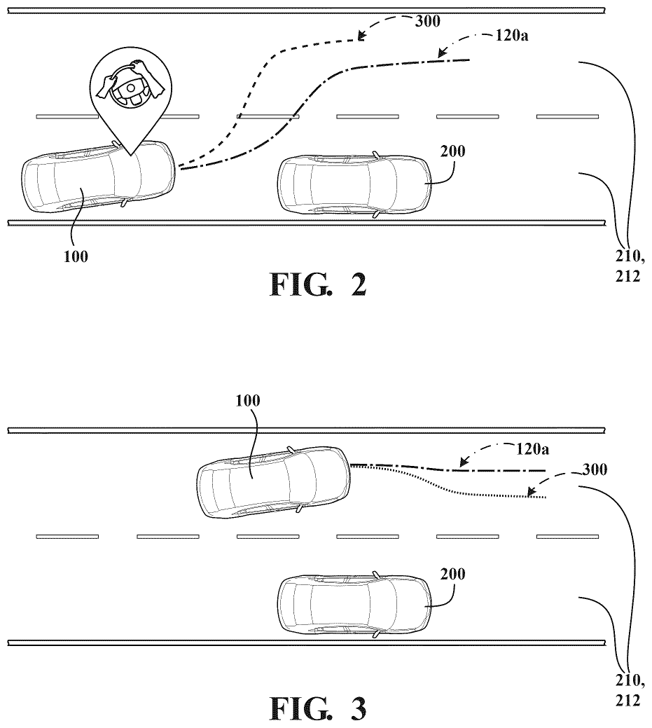

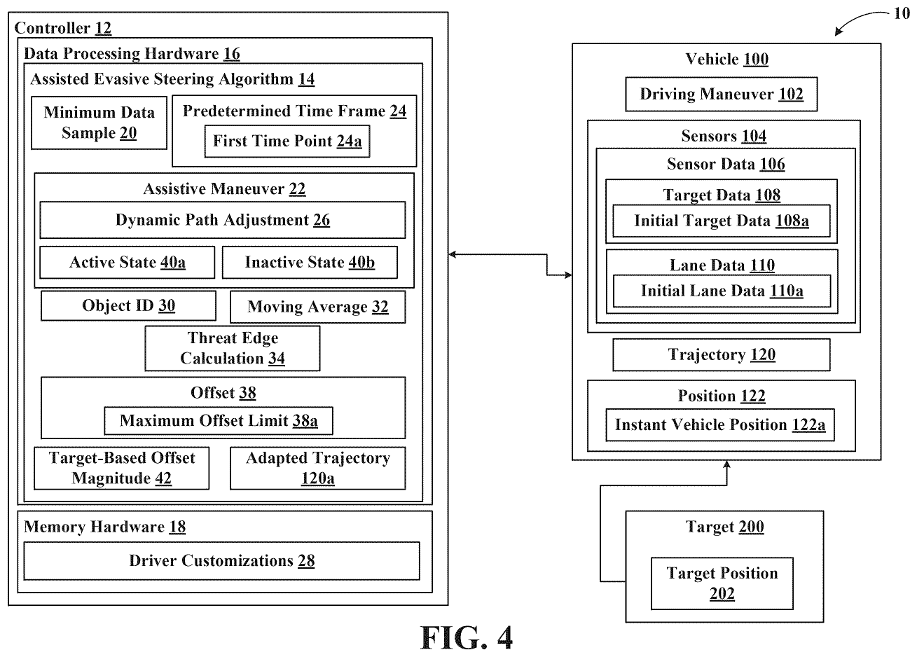

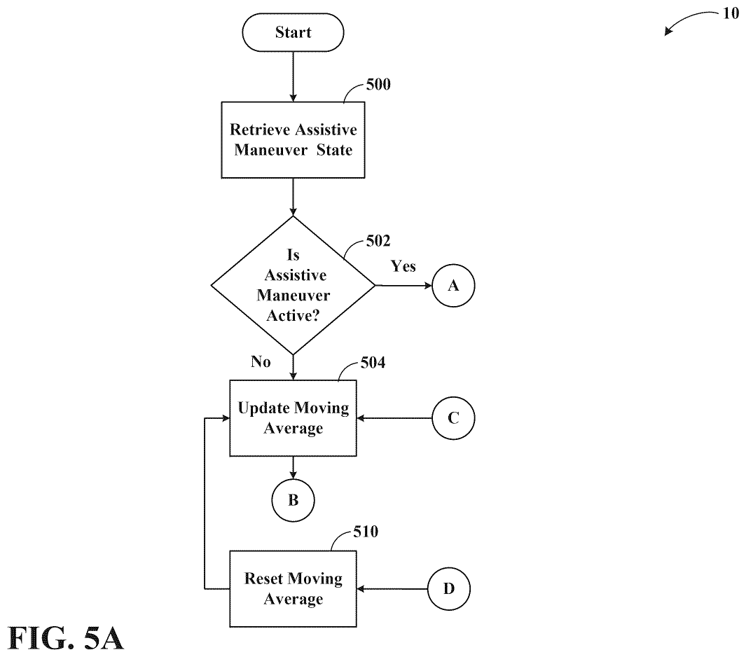

FIGS. 2 and 3 illustrate an execution of the assistive maneuver 22 (FIG. 4) at the vehicle 100 relative to the target 200 in comparison with an overcorrection maneuver 300. The overcorrection maneuver 300 is illustrated as a dashed line, and a desired or adapted trajectory 120a resulting from the assistive maneuver 22 is illustrated as a dash-dot line. As illustrated, the overcorrection maneuver 300 results in an adjustment that has a greater degree of initial adjustment as compared to the assistive maneuver 22. The assistive maneuver 22 provides the driver with a gradual adjustment that ultimately straightens the overall trajectory 120 of the vehicle 100 while the driver experiences minimal steering impact. The overcorrection maneuver 300, in comparison, would result in an aggressive adjustment applied to a steering wheel of the vehicle 100, which may cause the driver to react or otherwise move the steering wheel in an over-corrective manner. The overcorrection maneuver 300 is provided for illustrative and comparative purposes only and is not part of the assisted evasive steering system 10. While the assistive maneuver 22 may be utilized to compare and correct an overcorrection maneuver 300, it is also contemplated that the assistive maneuver 22 may adjust a standard trajectory of the vehicle 100 during a lane change operation irrespective of an overcorrection maneuver.

With further reference to FIGS. 2-4, the assisted evasive steering system 10 continuously monitors the driver maneuvers 102 of the vehicle 100 based on the sensor data 106. The assisted evasive steering algorithm 14 is configured with a predetermined time frame 24 during which the sensor data 106 is monitored prior to being purged. For example, the predetermined time frame 24 may, in one example, be fifteen (15) seconds during which the sensor data 106 is captured and monitored. The predetermined time frame 24 is a continuously running time frame, such that the next time frame 24 continues simultaneously from the previous time frame 24. The assisted evasive steering algorithm 14 is configured to purge data points of the sensor data 106 that time out of the predetermined time frame 24 and to monitor new sensor data 106 captured within the next predetermined time frame 24. Thus, the sensor data 106 is continuously captured, monitored, and purged until a driving maneuver 102 is detected.

As mentioned above, the assisted evasive steering algorithm 14 also estimates a minimum data sample 20 from the sensor data 106 based on the driving maneuver 102. The minimum data sample 20 is utilized to determine the predetermined time frame 24. The sensor data 106 is sampled for the predetermined time frame 24, and the assisted evasive steering algorithm 14 determines a maintained position 122 of the vehicle 100 during the predetermined time frame 24. The predetermined time frame 24 is reset based on the maintained position 122 of the vehicle 100. The assisted evasive steering algorithm 14 also utilizes the estimated minimum data sample 20 to determine how much sensor data 106 is needed for executing the assistive maneuver 22 in response to the detected driving maneuver 102. The minimum data sample 20 may be utilized by the assisted evasive steering algorithm 14 upon initial configuration or start-up of the vehicle 100 to set the predetermined time frame 24. After initialization, the assisted evasive steering algorithm 14 utilizes the sensor data 106 captured within the predetermined time frame 24 when detecting the driving maneuver 102.

Referring still to FIGS. 2-4, the predetermined time frame 24 includes a first time point 24a that corresponds to the detection of the driving maneuver 102. The first time point 24a corresponds to the initial target data 108a and the initial lane data 110a, such that the assisted evasive steering algorithm 14 begins monitoring the target 200 using the sensor data 106 at the first time point 24a. Prior to the first time point 24a, the assisted evasive steering algorithm 14 purges the sensor data 106 outside of the predetermined time frame 24. Once the driving maneuver 102 is detected, the first time point 24a is recorded, and the assisted evasive steering algorithm 14 begins evaluating the sensor data 106, the target 200, and the driving maneuver 102. The target 200 may be assigned an object identifier (ID) 30 that may be utilized to characterize the target 200 based on a target position 202.

While generating the sensor data 106 and the target 200, the assisted evasive steering algorithm 14 continuously updates and monitors a moving average 32 associated with a position of the target 200 relative to the vehicle 100. For example, other filtering methods could be used such as a low pass filter, root mean squared, or standard deviation. The moving average 32 is continuously monitored from the sensor data 106 by the assisted evasive steering algorithm 14 and may be reset based on updated target data 108. The moving average 32 may also be updated or altered based on the detected target position 202 of the target 200 relative to the vehicle 100 during execution of the driving maneuver 102. The assisted evasive steering algorithm 14 may execute a threat edge calculation 34, which utilizes the target data 108 and the lane data 110 to assess the target position 202.

For example, the threat edge calculation 34 is calculated from an average lateral position of the target 200, the average lateral position of the vehicle 100, and the lane data 110 (e.g., lane width). The threat edge calculation 34 represents the position of the target 200 relative to a center of the adjacent lane 212 at the onset of the maneuver. The assisted evasive steering algorithm 14 utilizes the threat edge position (i.e., the threat edge calculation 34) to generate an offset to the assistive maneuver 22, such that the threat edge calculation 34 may improve the trajectory 120 of the vehicle 100. This desired trajectory 120a can be further adapted by continuously monitoring and minimizing the error between the actual trajectory 120 and the desired trajectory 120a. The assisted evasive steering algorithm 14 utilizes the threat edge calculation 34 to generate the assistive maneuver 22, such that the assistive maneuver 22 may provide an adjustment to the driving maneuver 102 to improve the trajectory 120 of the vehicle 100. The improvement may result in continuous calculation throughout the assistive maneuver 22, thus minimizing an error between the actual trajectory and the desired trajectory.

The assistive maneuver 22 generally corresponds to the offset for a driving maneuver 102 based on the target position 202 relative to the center of the adjacent lane 212. The driving maneuver 102 corresponds to an initial trajectory that intends to place the vehicle 100 in the center of the adjacent lane 212. The threat edge calculation is configured to determine an offset based on a lateral position (i.e., target position 202) of the target 200 to the center of the adjacent lane 212. For example, the assisted evasive steering algorithm 14 is configured to calculate or otherwise generate a desired offset 38 based on the threat edge calculation 34. The assisted evasive steering algorithm 14 may be configured with maximum offset limits 38a for the desired offset 38 that are configured to limit the executed offset 38 as part of the assistive maneuver 22. The assistive maneuver 22 may shift the trajectory 120 based on the threat edge calculation 34 to provide an additional buffer zone for the vehicle 100 relative to the target 200 based on the target position 202.

The assisted evasive steering algorithm 14 is configured to generate the assistive maneuver 22 in response to the detection of the driving maneuver 102. The assisted evasive steering algorithm 14 is configured with a dynamic path adjustment 26 that is executed as part of the assistive maneuver 22 in response to the driving maneuver 102. The assisted evasive steering algorithm 14 utilizes the captured sensor data 106 within the predetermined time frame 24 to evaluate the driving maneuver 102 and determine what to execute as the assistive maneuver 22. For example, the assistive maneuver 22 may include a minor correction to the trajectory 120 in an effort to straighten the trajectory 120 in comparison to the projected trajectory 120, if the driving maneuver 102 were executed without the assistive maneuver 22.

The dynamic path adjustment 26 is configured to minimize error between an instant vehicle position 122a and a calculated optimal or adapted trajectory 120a of the vehicle 100. For example, the dynamic path adjustment 26 is calculated throughout the assistive maneuver 22 during which the driving maneuver 102 is being executed. The dynamic path adjustment 26 is configured to modify or adjust the assistive maneuver 22 to minimize abrupt changes to the driving maneuver while maximizing the ability to provide corrective assistance to the driving maneuver 102 resulting in the optimal trajectory 120a. The assistive maneuver 22 may be executed based on and/or in response to the dynamic path adjustment 26, such that the assistive maneuver 22 is generated based on the dynamic path adjustment 26 and the driving maneuver 102.

The assistive maneuver 22 is determined based on the target data 108, the lane data 110, the driving maneuver 102, and potential driver customizations 28. The driver customizations 28 may be stored in the memory hardware 18 and may include, but are not limited to, restrictions on the type of assistive maneuver 22. For example, a driver may choose to set a driver customization 28 that limits execution of the assistive maneuver 22 relative to a speed of the vehicle 100. The driver customizations 28 may be optional and may be selectively activated and deactivated by the driver.

With reference to FIGS. 2-6, the assisted evasive steering algorithm 14 may detect a driving maneuver 102 based on the sensor data 106 and may need to determine whether the assistive maneuver 22 is in an active state 40a or an inactive state 40b. For example, the assisted evasive steering algorithm 14 may detect the driving maneuver 102, and the assistive maneuver 22 may already be in the active state 40a. If the assistive maneuver 22 is in the active state 40a, then the assistive maneuver 22 is already primed with the moving average 32 relative to the target position 202 and the trajectory 120 of the driving maneuver 102. Thus, the assisted evasive steering algorithm 14 continues to monitor the driving maneuver 102 and assistive maneuver 22 until completion. In response, the assisted evasive steering algorithm 14 determines a target-based offset magnitude 42, which is utilized to refine and execute the assistive maneuver 22.

In other instances, the assistive maneuver 22 may be in the inactive state 40b, such that the driving maneuver 102 is being executed without the assistive maneuver 22. In response, the assisted evasive steering algorithm 14 may update the moving average 32 based on the target position 202 gathered from the target data 108 and determine whether the object ID 30 has changed. If the object ID 30 changes, then the assisted evasive steering algorithm 14 resets the moving average 32.

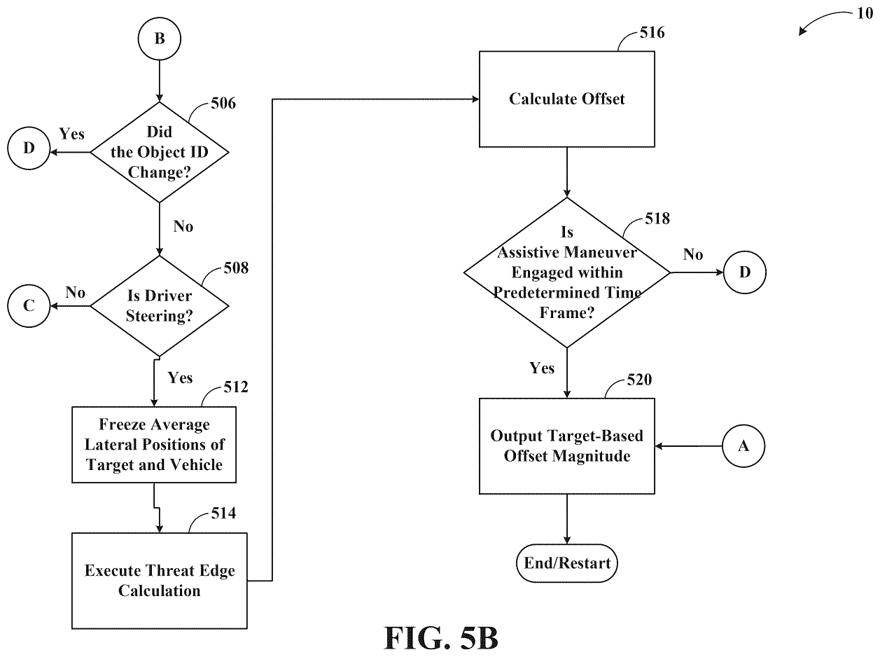

FIGS. 5A and 5B illustrate a flow diagram of the operation of the assisted evasive steering algorithm 14 to further illustrate the process of executing the assistive maneuver 22. At 500, the assisted evasive steering algorithm 14 retrieves the state 40a, 40b of the assistive maneuver 22. At 502, the assisted evasive steering algorithm 14 determines whether the assistive maneuver 22 is active. If the assistive maneuver 22 is inactive, the assisted evasive steering algorithm 14 updates, at 504, the moving average 32, and determines, at 506, whether the object ID 30 changed. If the object ID 30 did change, then the assisted evasive steering algorithm 14 resets the moving average 32. If the object ID 30 did not change, then the assisted evasive steering algorithm 14 determines, at 508, whether the driver is steering. If the driver is not steering, then the assisted evasive steering algorithm 14 updates, at 510, the moving average 32.

If the driver is steering, then the assisted evasive steering algorithm 14 freezes the current average lateral position of the target 200 and average lateral position of the vehicle 100, at 512, and executes, at 514, the threat edge calculation 34. The assisted evasive steering algorithm 14 calculates, at 516, the offset 38 and determines, at 518, whether the assistive maneuver 22 is engaged within the predetermined time frame 24. If the assistive maneuver 22 is engaged within the predetermined time frame 24, then the assisted evasive steering algorithm 14 outputs, at 520, the target-based offset magnitude 42. If the assistive maneuver 22 is not engaged within the predetermined time frame 24, then the assisted evasive steering algorithm 14 resets, at 510, the moving average 32 and updates the moving average 32. If the assisted evasive steering algorithm 14 determines, at 502, that the assistive maneuver is active, then the assisted evasive steering algorithm 14 outputs, at 520, the target-based offset magnitude 42.

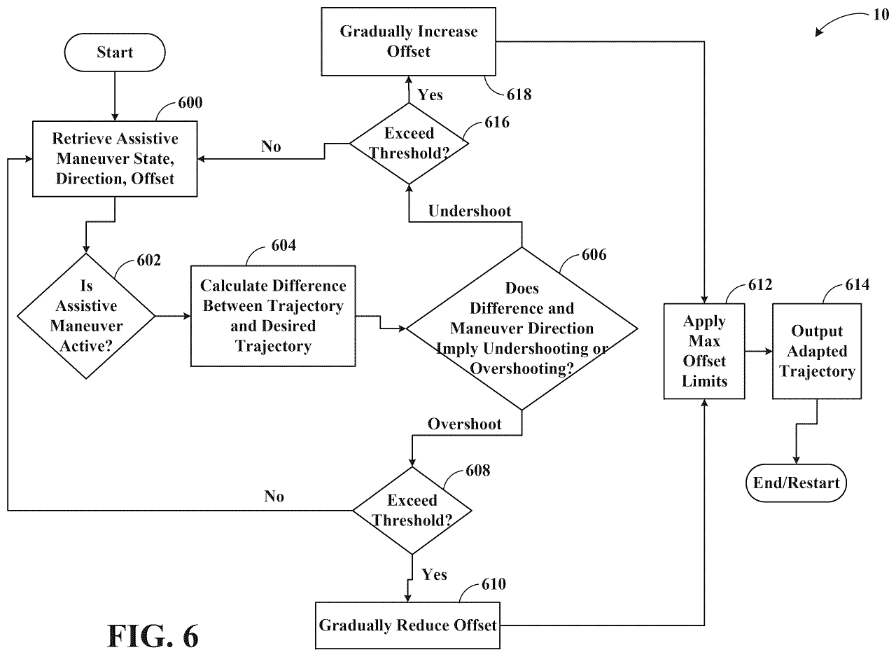

FIG. 6 illustrates another example flow diagram of the assisted evasive steering algorithm 14. At 600, the state 40a, 40b of the assistive maneuver 22 is retrieved, and the assisted evasive steering algorithm 14 determines, at 602, whether the assistive maneuver 22 is engaged. If the assistive maneuver 22 is not engaged, then the assisted evasive steering algorithm 14 awaits retrieval of the assistive maneuver 22 in the active state 40a. If the assistive maneuver 22 is engaged or in the active state 40a, then the assisted evasive steering algorithm 14 calculates, at 604, a difference between the trajectory 120 and the desired trajectory 120a. The assisted evasive steering algorithm 14 determines, at 606, if the difference and the maneuver direction imply undershooting or overshooting. If the difference and the maneuver direction imply an overshoot, the assistive evasive steering algorithm 14 determines, at 608 whether a threshold is exceeded. The threshold is a deadband so that the offset 38 is increased or decreased only in response to the difference between the desired trajectory 120a and the trajectory 120 exceeding the threshold. If the difference exceeds the threshold, then the assisted evasive steering algorithm 14 returns to step 600. If the threshold is exceeded, then the assisted evasive steering algorithm 14 gradually increases, at 610, the offset 38 and applies, at 612, a maximum offset limit 38a. At 614, the assisted evasive steering algorithm 14 outputs the adapted trajectory 120a.

If the difference and maneuver direction imply an undershoot, then the assisted evasive steering algorithm 14 determines, at 616, whether the difference exceeds the threshold. If the difference does not exceed the threshold, then the assisted evasive steering algorithm 14 returns to step 600. If the difference does exceed the threshold, then the assisted evasive steering algorithm 14 gradually reduces, at 618, the offset 38 and applies, at 612, the maximum offset limit 38a. The assisted evasive steering algorithm 14 then outputs, at 614, the adapted trajectory 120a.

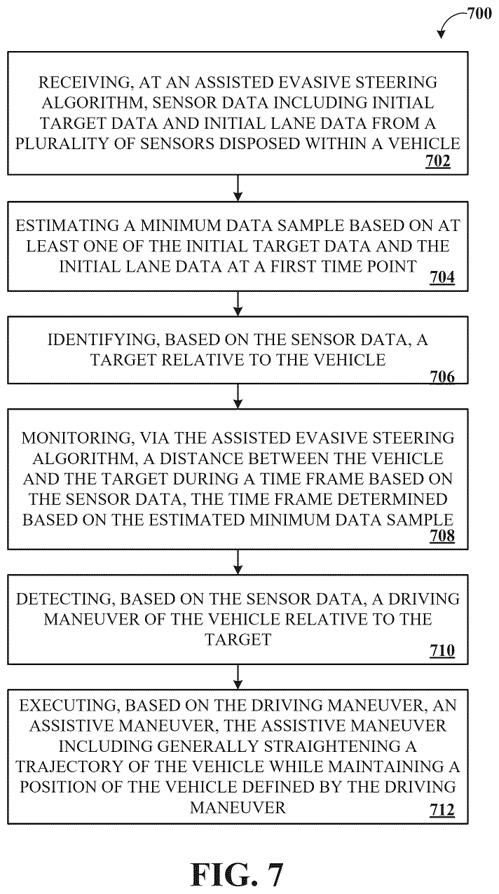

FIG. 7 illustrates an exemplary method 700 of operation of the assisted evasive steering system 10. At 702, the assisted evasive steering algorithm 14 receives sensor data 106 including initial target data 108a and initial lane data 110a from a plurality of sensors 104 disposed within a vehicle 100. A minimum data sample 20 is estimated, at 704, based on at least one of the initial target data 108a and the initial lane data 110a at a first time point 24a. The assisted evasive steering algorithm 14 identifies, at 706, a target 200 relative to the vehicle 100 based on the sensor data 106. At 708, the assisted evasive steering algorithm 14 monitors a distance between the vehicle 100 and the target 200 during a time frame 24 based on the sensor data 106. The time frame 24 is determined based on the estimated minimum data sample 20. A driving maneuver 102 of the vehicle 100 relative to the target 200 is detected, at 710, based on the sensor data 106. The assisted evasive steering algorithm 14 executes, at 712, an assistive maneuver 22 based on the driving maneuver 102. The assistive maneuver 22 includes generally straightening a trajectory 120 of the vehicle 100 while maintaining a position of the vehicle 100 defined by the driving maneuver 102.

Referring again to FIGS. 1-7, the assisted evasive steering system 10 advantageously assists drivers in positioning the vehicle 100 relative to a target 200 during a driving maneuver 102 without overcompensating for a correction to the driving maneuver 102. The assistive maneuver 22 is designed to provide gradual and minimal adjustment to the driving maneuver 102 to provide corrective assistance to the trajectory 120 while maintaining trust of the driver. The driver may experience a minor shift or adjustment at a steering wheel of the vehicle 100 during execution of the assistive maneuver 22, such that the driver may remain at ease with the operation of the assistive maneuver 22. The assisted evasive steering algorithm 14 utilizes the various sensor data 106 to determine the degree to which the assistive maneuver 22 is executed to provide an adapted trajectory 120a while maintaining trust in the driving maneuver 102 by the driver. Thus, the assistive maneuver 22 may generally straighten the trajectory 120 without forcing the vehicle 100 into a center position of the lane 212 in the event that the trajectory 120 is off-center.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method that, when executed by data processing hardware, causes the data processing hardware to perform operations comprising:
receiving, at an assisted evasive steering algorithm, sensor data from a plurality of sensors disposed within a vehicle, the sensor data including target data and lane data;
identifying, based on the sensor data, a target relative to the vehicle, the target being another vehicle;
monitoring, via the assisted evasive steering algorithm, a distance between the vehicle and the target during a time frame based on the sensor data;
detecting, based on the sensor data, a driving maneuver of the vehicle relative to the target;
executing, via the assisted evasive steering algorithm, a threat edge calculation based on an average lateral position of the vehicle, an average lateral position of the target, and the lane data, the threat edge calculation representing a position of the target relative to a center of an adjacent lane at an onset of the driving maneuver;
determining, based on the threat edge calculation, a target-based offset magnitude; and
executing, based on the driving maneuver and the target-based offset magnitude, an assistive maneuver, the assistive maneuver including straightening a trajectory of the vehicle while maintaining a position of the vehicle defined by the driving maneuver.

2. The method of claim 1, wherein the assisted evasive steering algorithm includes a dynamic path adjustment.

3. The method of claim 2, wherein executing the assistive maneuver includes executing the dynamic path adjustment in response to the driving maneuver.

4. The method of claim 1, wherein receiving the sensor data includes receiving initial target data and initial lane data from the plurality of sensors at a first time point.

5. The method of claim 4, further including estimating a minimum data sample based on at least one of the initial target data and the initial lane data at the first time point.

6. The method of claim 5, further including determining the time frame for monitoring the distance between the vehicle and the target based on the minimum data sample.

7. The method of claim 5, further including sampling the sensor data for the time frame and determining a maintained position of the vehicle during the time frame.

8. The method of claim 7, further including resetting the time frame based on the maintained position of the vehicle.

9. An assisted evasive steering system for a vehicle, the assisted evasive steering system comprising:
data processing hardware; and
memory hardware in communication with the data processing hardware, the memory hardware storing instructions that when executed on the data processing hardware cause the data processing hardware to perform operations comprising:
receiving, at an assisted evasive steering algorithm, sensor data from a plurality of sensors disposed within the vehicle, the sensor data including target data and lane data;
identifying, based on the sensor data, a target relative to the vehicle, the target being another vehicle;
monitoring, via the assisted evasive steering algorithm, a distance between the vehicle and the target during a time frame based on the sensor data;
detecting, based on the sensor data, a driving maneuver of the vehicle relative to the target;
executing, via the assisted evasive steering algorithm, a threat edge calculation based on an average lateral position of the vehicle, an average lateral position of the target, and the lane data, the threat edge calculation representing a position of the target relative to a center of an adjacent lane at an onset of the driving maneuver;
determining, based on the threat edge calculation, a target-based offset magnitude; and
executing, based on the driving maneuver and the target-based offset magnitude, an assistive maneuver, the assistive maneuver including straightening a trajectory of the vehicle while maintaining a position of the vehicle defined by the driving maneuver.

10. The assisted evasive steering system of claim 9, wherein the assisted evasive steering algorithm includes a dynamic path adjustment.

11. The assisted evasive steering system of claim 10, wherein executing the assistive maneuver includes executing the dynamic path adjustment in response to the driving maneuver.

12. The assisted evasive steering system of claim 9, wherein receiving the sensor data includes receiving initial target data and initial lane data from the plurality of sensors at a first time point.

13. The assisted evasive steering system of claim 12, further including estimating a minimum data sample based on at least one of the initial target data and the initial lane data at the first time point.

14. The assisted evasive steering system of claim 13, further including determining the time frame for monitoring the distance between the vehicle and the target based on the minimum data sample.

15. The assisted evasive steering system of claim 13, further including sampling the sensor data for the time frame and determining a maintained position of the vehicle relative to the target during the time frame.

16. The assisted evasive steering system of claim 15, further including resetting the time frame based on the maintained position of the vehicle.

17. An assisted evasive steering system for a vehicle, the assisted evasive steering system comprising:
data processing hardware; and
memory hardware in communication with the data processing hardware, the memory hardware storing instructions that when executed on the data processing hardware cause the data processing hardware to perform operations comprising:
receiving, at an assisted evasive steering algorithm, sensor data including initial target data and initial lane data from a plurality of sensors disposed within the vehicle;
estimating a minimum data sample based on at least one of the initial target data and the initial lane data at a first time point;
identifying, based on the sensor data, a target relative to the vehicle, the target being another vehicle;
monitoring, via the assisted evasive steering algorithm, a distance between the vehicle and the target during a time frame based on the sensor data, the time frame determined based on the estimated minimum data sample;
detecting, based on the sensor data, a driving maneuver of the vehicle relative to the target;
executing, via the assisted evasive steering algorithm, a threat edge calculation based on an average lateral position of the vehicle, an average lateral position of the target. and the initial lane data, the threat edge calculation representing a position of the target relative to a center of an adjacent lane at an onset of the driving maneuver;
determining, based on the threat edge calculation, a target-based offset magnitude; and
executing, based on the driving maneuver and the target-based offset magnitude, an assistive maneuver, the assistive maneuver including straightening a trajectory of the vehicle while maintaining a position of the vehicle defined by the driving maneuver.

18. The assisted evasive steering system of claim 17, wherein the assisted evasive steering algorithm includes a dynamic path adjustment.

19. The assisted evasive steering system of claim 17, further including sampling the sensor data for the time frame and determining a maintained position of the vehicle relative to the target during the time frame.

20. The assisted evasive steering system of claim 19, further including resetting the time frame based on the maintained position of the vehicle.
